(19) United States
(12) Patent Application Publication
(10) Pub. No.: US 2020/0134957 A1
(43) Pub. Date: Apr. 30, 2020

(54) BANKNOTE PROCESSING APPARATUS

(71) Applicant: GLORY LTD., Hyogo (JP)

(72) Inventor: Takeshi YOKAWA, Hyogo (JP)

(73) Assignee: GLORY LTD., Hyogo (JP)

(21) Appl. No.: 16/493,481

(22) PCT Filed: Feb. 28, 2018
(86) PCT No.: PCT/JP2018/007506

§ 371 Date: Sep. 12, 2019

(30) Foreign Application Priority Data
Mar. 15, 2017 (JP) 2017-049787

(51) Int. Cl. G07D 11/40; G07D 11/125; G07D 11/00; E05G 1/04; E05G 1/06

(52) U.S. Cl. CPC G07D 11/40; G07D 11/125; E05G 1/06; E05G 1/04; G07D 11/009

(57) ABSTRACT

This banknote processing apparatus has: an upper unit including a depositing unit configured to deposit a banknote in the banknote processing apparatus and a banknote recognition unit configured to recognize the banknote deposited from the depositing unit; and a lower unit including a temporary storage unit configured to temporarily store the banknote recognized by the banknote recognition unit and a banknote storage unit configured to store the banknote stored in the temporary storage unit. Thus, the temporary storage unit is housed in the lower unit, and therefore a user can easily perform maintenance of the temporary storage unit.

### TECHNICAL FIELD

The present invention relates to a banknote processing apparatus.

### BACKGROUND ART

Some conventional banknote processing apparatuses are roughly divided into a processing unit at an upper portion, a first safe unit at an intermediate portion, and a second safe unit at a lower portion. In such a banknote processing apparatus, the processing unit at the upper portion contains various devices such as a depositing unit, a dispensing unit, a transport unit, a recognition unit, and a temporary storage unit (refer to PTL 1, for example).

### CITATION LIST

### Patent Literature

PTL 1
Japanese Patent No. 6042950

### SUMMARY OF INVENTION

### Technical Problem

However, in PTL 1, due to the aforementioned various devices incorporated in the processing unit at the upper portion, the processing unit at the upper portion is overcrowded with the various devices thereinside, and there is a problem of difficulty in accessing the temporary storage unit.

An object of the present invention is to provide a technique to facilitate the access to the temporary storage unit.

### Solution to Problem

A banknote processing apparatus of the present invention comprises: an upper unit including a depositing unit and a banknote recognition unit, the depositing unit being configured to deposit a banknote in the banknote processing apparatus, the banknote recognition unit being configured to recognize the banknote deposited from the depositing unit; and a lower unit including a temporary storage unit and a banknote storage unit, the temporary storage unit being configured to temporarily store the banknote recognized by the banknote recognition unit, the banknote storage unit being configured to store the banknote stored in the temporary storage unit.

### Advantageous Effects of Invention

According to the present invention, access to a temporary storage unit is facilitated.

### BRIEF DESCRIPTION OF DRAWINGS

FIG. 1 is a perspective view of a banknote processing apparatus according to Embodiment 1;

FIG. 2 is a schematic sectional of the banknote processing apparatus of FIG. 1 as viewed from the +y axis direction;

FIG. 3 is a schematic sectional view of a transport nodule as viewed from the +y axis direction;

FIG. 4 is another schematic sectional view of the banknote processing apparatus of FIG. 1 as viewed from the +y axis direction;

FIG. 5 is a schematic sectional view of a banknote processing apparatus according to Embodiment 2 as viewed from the +y axis direction;

FIG. 6 is a schematic perspective view of a temporary storage unit when a door of a lower unit is opened;

FIG. 7 is a schematic sectional view of the temporary storage unit as viewed from the +y axis direction;

FIG. 8 is a schematic sectional view of a temporary storage unit for comparison with the temporary storage unit of FIG. 7;

FIG. 9 is a schematic sectional view of a banknote processing apparatus according to Embodiment 3 as viewed from the +y axis direction;

FIG. 10 is a schematic perspective view of a temporary storage unit when a door of a lower unit is opened;

FIG. 11 is a schematic sectional view of a banknote processing apparatus according to Embodiment 4 as viewed from the +y axis direction;

FIG. 12 is a perspective view of the banknote processing apparatus of FIG. 11; and

FIG. 13 is a schematic sectional view of a banknote processing apparatus according to Embodiment 5 as viewed from the +y axis direction.

### DESCRIPTION OF EMBODIMENTS

Embodiments of the present invention will be described with reference to the accompanying drawings.

### Embodiment 1

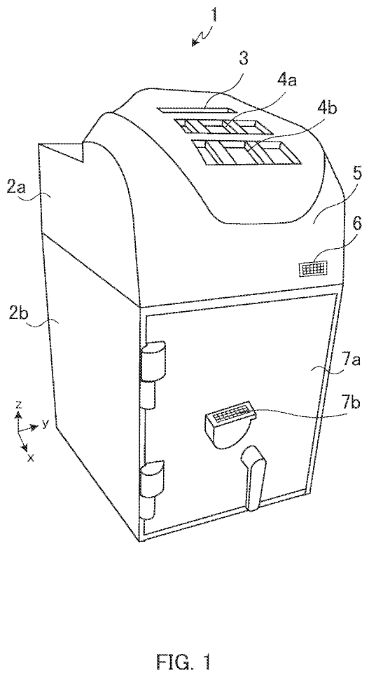

FIG. 1 is a perspective view of a banknote processing apparatus 1 according to Embodiment 1. The banknote processing apparatus 1 illustrated in FIG. 1 is used in a field in which a lot of cash is handled, such as a bank and a supermarket. For example, the banknote processing apparatus 1 is used for deposit and dispensing, counting, storage management, and the like of cash in work for receipts and disbursements at a bank counter, work for proceeds from sales at a supermarket, or the like. Hereinafter, a rectangular coordinate system having x, y and z axes illustrated in FIG. 1 is set with respect to the banknote processing apparatus 1.

As illustrated in FIG. 1, the banknote processing apparatus 1 is divided into an upper unit 2a and a lower unit 2b.

The upper unit 2a has a depositing unit 3, dispensing units 4a, 4b, an upper cover 5, and a locking unit 6. The depositing unit 3 is an inlet into which a banknote to be deposited in the banknote processing apparatus 1 is put. The dispensing units 4a, 4b each are an outlet from which a banknote dispensed from the banknote processing apparatus 1 is taken out. The dispensing units 4a, 4b each are an outlet from which a rejected banknote, a banknote which cannot be recognized, or the like is taken out.

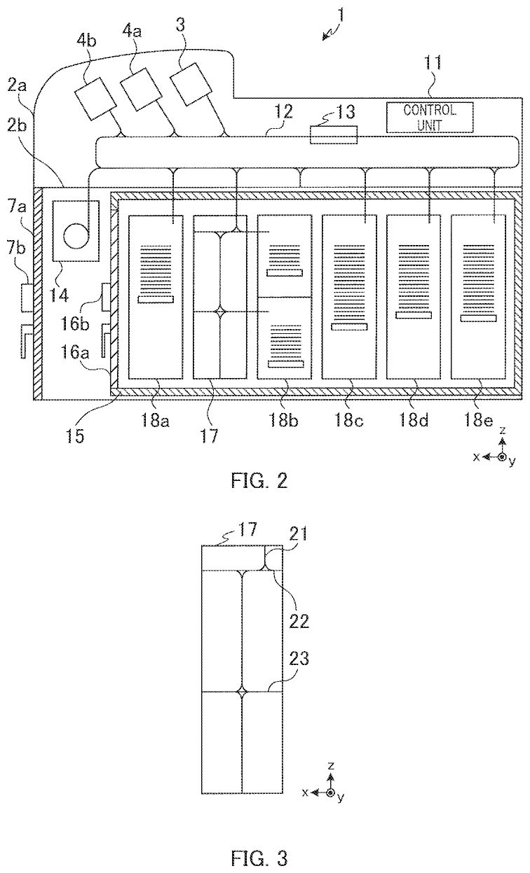

The upper cover 5 is a cover that covers at least a front surface of the upper unit 2a. The upper cover 5 is fixed to a body of the upper unit 2a and locked by the locking unit 6. Once the locking unit 6 is unlocked, the upper cover 5 can be drawn out forward from the body of the upper unit 2a together with various devices (for example, refer to the depositing unit 3, the dispensing units 4a, 4b, a control unit 11, a transport unit 12, or a recognition unit 13 illustrated in FIG. 2) in the upper unit 2a, which will be described below.

The locking unit 6 is provided on a front surface of the upper cover 5. The locking unit 6 is, for example, an electronic lock, and limits access to the inside of the upper unit 2a. For example, when a preset personal identification number which serves as the unlocking information is input to the locking unit 6, the locking unit 6 is unlocked with the unlocking information and allows the various devices in the upper unit 2a to be drawn from the body of the upper unit 2a.

Consequently, a user who has specific authority of knowing the personal identification number of the locking unit 6 can access the inside of the upper unit 2a. For example, the user who has the specific authority can access the various devices in the upper unit 2a.

The lower unit 2b has an door 7a to be opened or closed, and a locking unit 7b. The door 7a is a door for accessing the inside of the lower unit 2b.

On a front surface of the door 7a, the locking unit 7b is provided. The locking unit 7b is, for example, an electronic lock, and limits access to the inside of the lower unit 2b. For example, when a preset personal identification number preset as unlocking information is input to the locking unit 7b, the locking unit 7b is unlocked and the door 7a can be opened.

Consequently, a user who has specific authority of knowing the personal identification number of the locking unit 7b can access the inside of the lower unit 2b. For example, the user who has the specific authority can access a temporary storage unit or a safe (for example, refer to a temporary storage unit 14 or a safe 15 illustrated in FIG. 2) inside lower unit 2b described below.

The aforementioned locking units 6, 7b are not limited to the electronic locks. The locking units 6, 7b may be locks such as cylinder locks.

FIG. 2 is a schematic sectional view of the banknote processing apparatus 1 of FIG. 1 as viewed from the axis direction. In FIG. 2, the same components as FIG. 1 are denoted by the same reference numerals. In FIG. 2, illustration of the shape and the like of the banknote processing apparatus 1 of FIG. 1 is simplified.

As illustrated in FIG. 2, the upper unit 2a of the banknote processing apparatus 1 has the control unit 11, the transport unit 12, and the recognition unit 13.

The control unit 11 controls the whole of the banknote processing apparatus 1. For example, the control unit 11 performs depositing of banknotes deposited in the depositing unit 3. Specifically, the control unit 11 causes the transport unit 12 to transport the banknotes deposited in the depositing unit 3 to the recognition unit 13. The control unit 11 causes the recognition unit 13 to recognize authenticity, fitness, denomination, or the like of the banknotes. The control unit 11 temporarily stores normal banknotes and the like in the temporary storage unit 14 of the lower unit 2b on the basis of a recognition result of the recognition unit 13, and transports rejected banknotes to the dispensing units 4a, 4b. Then, for example, when a user performs deposit determination operation or the like, the control unit 11 transports the banknotes temporarily stored in the temporary storage unit 14 to the banknote storage units 18a to 18e.

The control unit 11 performs dispensing of the banknotes stored in the banknote storage units 18a to 18e, for example. Specifically, the control unit 11 feeds out banknotes in response to a dispensing request from the user from the banknote storage units 18a to 18e. The control unit 11 causes a transport module 17 and the transport unit 12 to transport the fed banknotes to the dispensing units 4a, 4b. The control unit 11 implements the aforementioned function by a device including a CPU (Central Processing Unit), a memory that stores a program and a predetermined data, and the like, for example.

The transport unit 12 has a loop-shaped transport path. The transport unit 12 is connected to the depositing unit 3, the dispensing units 4a, 4b, the temporary storage unit 14, the transport module 17, and the banknote storage units 18a to 18e. The transport unit 12 transports the banknotes to each unit in response to an instruction of the control unit 11.

The recognition unit 13 is provided on the transport unit 12. The recognition unit 13 includes an image sensor, an infrared sensor, an ultraviolet sensor, a magnetic sensor, or the like, and recognizes authenticity, fitness, denomination or the like of banknotes that are transported on the transport unit 12.

The lower unit 2b has the temporary storage unit 14, the safe 15, an door 16a to be opened or closed, a locking unit 16b, the transport module 17, and the banknote storage units 18a to 18e.

The temporary storage unit 14 temporarily stores banknotes put into the depositing unit 3, for example. Additionally, the temporary storage unit 14 temporarily stores a rejected banknote or the like caused at the time of dispensing, for example. The temporary storage unit 14 is a winding type storage unit having a winding drum which winds a banknote, for example.

The temporary storage unit 14 is disposed in the lower unit 2b. For example, the temporary storage unit 14 is installed in a space between a front surface of the safe 15 of the lower unit 2b, and the door 7a. In other words, the temporary storage unit 14 is disposed outside the safe 15 and inside the lower unit 2b.

Herein, the upper unit 2a has various devices such as the depositing unit 3, the dispensing units 4a, 4b, the control unit 11, the transport unit 12, and the recognition unit 13. Therefore, when the temporary storage unit 14 is disposed in the upper unit 2a, the temporary storage unit 14 is mingled with the various devices, and it is difficult for the user to access the temporary storage unit 14. Specifically, even when the locking unit 6 is unlocked and the various devices in the upper unit 2a is drawn out forward, there is a case where the various devices such as the depositing unit 3, the dispensing units 4a, 4b, the control unit 11, the transport unit 12, and the recognition unit 13 become obstacles, and the temporary storage unit 14 is disposed so as to be unlikely to be accessed from outside. Therefore, it becomes difficult to perform work for removing a banknote retaining in the temporary storage unit 14, or replacing parts of the temporary storage unit 14.

However, as described above, the temporary storage unit 14 is disposed in the lower unit 2b that does not has the various devices such as the depositing unit 3, the dispensing units 4a, 4b, the control unit 11, the transport unit 12, and the recognition unit 13 therein. More specifically, as described above, the temporary storage unit 14 is disposed in a space between the front surface of the safe 15, and the door 7a. Once the locking unit 7b is unlocked and the door 7a is opened, the temporary storage unit 14 is brought into a state of being exposed to the outside.

Consequently, the user can easily access the temporary storage unit 14, and can easily perform maintenance of the temporary storage unit 14. More specifically, when the user opens the door 7a, the user can access the temporary storage unit 14, and can easily perform maintenance of the temporary storage unit 14.

The safe 15 houses the transport module 17, and the banknote storage units 18a to 18e. The safe 15 has the door 16a and the locking unit 16b on the front surface. When the locking unit 16b is unlocked and the door 16a is opened, the inside of the safe 15 can be accessed.

The locking unit 16b is provided on a front surface of the door 16a. The locking unit 16b is, for example, an electronic lock, and limits access to the inside of the safe 15 when the door 16a is closed and the locking unit 16b is locked. For example, when a preset personal identification number is input to the locking unit 16b, the locking unit 16b is unlocked and the door 16a can be opened.

Consequently, a user who has specific authority of knowing the personal identification number of the locking unit 16b can access the inside of the safe 15. For example, the user who has the specific authority can access the banknote storage units 18a to 18e housed in the safe 15.

The transport module 17 is housed in the safe 15. The transport module 17 is detachable from the safe 15. The transport module 17 has a transport path connecting the transport unit 12 and a banknote storage unit 18b.

The temporary storage unit 14 is a storage unit that stores a banknote therein. The banknote storage units 18a to 18e each are also a storage unit that stores a banknote therein. In Embodiment 1, these storage units are collectively disposed in the lower unit 2b. On the other hand, a storage unit that stores a banknote therein is not disposed in the upper unit 2a. Thus, the banknote processing apparatus 1 has functionally distinguished units, namely, the lower unit 2b having a storage function, and the upper unit 2a having a processing function such as depositing and dispensing, and recognition of a banknote.

FIG. 3 is a schematic sectional view of the transport module 17 as viewed from the +y axis direction. As illustrated in FIG. 3, the transport module 17 has transport units (transport paths) 21 to 23.

In a state in which the transport module 17 is attached to the safe 15 (for example, the state illustrated in FIG. 2), the transport unit 21 illustrated in FIG. 3 is connected to a transport unit connected to a transport unit 12 of FIG. 2. The transport unit 22 illustrated in FIG. 3 is connected to a transport unit connected to a storage unit on an upper side of the banknote storage unit 18b of FIG. 2. The transport unit 23 illustrated in FIG. 3 is connected to a transport unit connected to a storage unit on a lower side of the banknote storage unit 18b of FIG. 2.

The transport module 17 has a plurality of diverters that switch banknote transport routes. The transport module 17 switches transport destinations of a banknote in accordance of control of the diverters by the control unit 11.

For example, the transport module 17 transports a banknote transported from the transport unit 12 of FIG. 2 to the transport unit 22 to transport the banknote to the storage unit on the upper side of the banknote storage unit 18b of FIG. 2, or transports a banknote transported from the transport unit 12 of FIG. 2 to the transport unit 23 to transport the banknote to the storage unit on the lower side of the banknote storage unit 18b of FIG. 2. The transport module 17 transports the banknote fed out from the storage unit on the upper side of the banknote storage unit 18b of FIG. 2 to the transport unit 21 to transport the banknote to the transport unit 12 of FIG. 2, or transports the banknote fed out from the storage unit on the lower side of the banknote storage unit 18b of FIG. 2 to the transport unit 21 to transport the banknote to the transport unit 12 of FIG. 2.

The transport module 17 can be replaced with one of the banknote storage units 18a to 18e illustrated in FIG. 2. For example, the transport module 17 can be mounted at a position of the banknote storage unit 18c illustrated in FIG. 2. In this case, at a position of the banknote storage unit 18d of FIG. 2, the banknote storage unit 18b including the two storage units are located. That is, the banknote processing apparatus 1 can flexibly compose the transport path and the banknote storage units by the detachable transport module 17.

The explanation of FIG. 2 will be continued. The banknote storage units 18a to 18e are housed in the safe 15. The banknote storage units 18a to 18e are detachable from the safe 15.

The banknote storage units 18a, 18c to 18e each have an opening for storing and feeding out a banknote in an upper surface. The banknote storage units 18a, 18c to 18e each store the banknote transported from the transport unit 12, from the opening provided in the upper surface. Additionally, the banknote storage units 18a, 18c to 18e each feed out the stored banknote from the opening provided on the upper surface to the transport unit 12.

The banknote storage unit 18b has the two storage unit in the vertical direction (z-axis direction). The banknote storage unit 18b has an opening for storing and feeding out a banknote in a side surface in each of the two storage units. The banknote storage unit 18b stores the banknote transported from the transport module 17, from the opening provided in the side surface. Additionally, the banknote storage unit 18b feeds out the stored banknote from the opening provided in the side surface to the transport module 17.

The transport module 17 and the banknote storage units 18a to 18e are installed on a rail (not illustrated) provided on a bottom surface inside the safe 15 so as to be movable in the front surface and back surface directions of the safe 15 (x-axis direction)), for example. Consequently, the user can take out the transport module 17 and the banknote storage units 18a to 18e to the outside of the safe 15. For example, the user opens the door 7a of the lower unit 2b, removes the temporary storage unit 14, and opens the door 16a of the safe 15, so that the user can take out the transport module 17 and the banknote storage units 18a to 18e to the outside of the safe 15. Additionally, the user can house, in the safe 15, the transport module 17 and the banknote storage units 18a to 18e taken out to the outside of the safe 15.

Management authority of the banknote processing apparatus 1 will be described. First, the upper unit 2a and the lower unit 2b have the locking unit 6 and the locking unit 7b, respectively, as illustrated in FIG. 1. Consequently, the upper unit 2a and the lower unit 2b are managed under different management authority, respectively.

Furthermore, the temporary storage unit 14 and the banknote storage units 18a to 18e in the lower unit 2b are disposed in respective regions isolated from each other by the safe 15 having the locking unit 16b. For example, the temporary storage unit 14 is disposed inside the lower unit 2b and outside the safe 15, and the banknote storage units 18a to 18e are disposed inside the lower unit 2b and inside the safe 15. Consequently, the temporary storage unit 14 and the banknote storage units 18a to 18e in the lower unit 2b are managed under different management authority, respectively.

Namely, the upper unit 2a, the temporary storage unit 14 of the lower unit 2b, the banknote storage units 18a to 18e of the lower unit 2b are managed under different management authority, respectively.

For example, the personal identification number of the locking unit 6 of the upper unit 2a is informed to a user who has authority to access the inside of the upper unit 2a. The personal identification number of the locking unit 7b for opening the door 7a of the lower unit 2b is informed to a user who has authority to access the temporary storage unit 14 of the lower unit 2b. The personal identification number of the locking unit 7b for opening the door 7a of the lower unit 2b, and the personal identification number of the locking unit 16b for opening the door 16a of the safe 15 are informed to a user who has authority to access the banknote storage units 18a to 18e of the lower unit 2b. Consequently, the upper unit 2a, the temporary storage unit 14, and the banknote storage units 18a to 18e are managed under different management authority, respectively.

For example, in a case in which the locking units 6, 7b, 16b are cylinder keys of the cylinder locks only need to be given to the respective users who have the management authority of the upper unit 2a, the management authority of the temporary storage unit 14, and the management authority of the banknote storage units 18a to 18e.

The personal identification numbers of the locking units 6, 7b, 16b as the keys are different from each other such that the user having each management authority cannot access a portion of other management authority. In a case in which the locking units 6, 7b, 16b are the cylinder locks, the keys of the locking units 6, 7b, 16b are different in each management authority.

As described above, the upper unit 2a of the banknote processing apparatus 1 has the depositing unit 3 in which banknotes are deposited, and the recognition unit 13 that recognizes the banknotes deposited from the depositing unit 3. The lower unit 2b has the temporary storage unit 14 that temporarily stores the banknotes recognized by the recognition unit 13, and the banknote storage units 18a to 18e each storing the banknote temporarily stored in the temporary storage unit 14. Thus, the temporary storage unit 14 is housed in the lower unit 2b, and therefore a user can easily perform maintenance of the temporary storage unit 14.

The temporary storage unit 14 is provided between the door 16a of the safe 15, and the door 7a of the lower unit 2b. Consequently, the height of the banknote processing apparatus 1 can be reduced compared to a case tri which the temporary storage unit 14 is disposed in the upper unit 2a. For example, the upper unit 2a houses various devices such as the depositing unit 3 and the recognition unit 13. Therefore, if the temporary storage unit 14 is disposed in the upper unit 2a, the height of the upper unit 2a is increased. On the other hand, the temporary storage unit 14 is provided between the door 16a of the safe 15 and the door 7a of the lower unit 2b, and therefore the height of the upper unit 2a can be reduced.

The banknote processing apparatus 1 has the locking unit 6 that limits access to the inside of the upper unit 2a, the locking unit 7b that limits access to the region where the temporary storage unit 14 is provided, and the locking unit 16b that limits access to the region where the banknote storage units 18a to 18e are provided. Consequently, it is possible to separate the management authority of the upper unit 2a, the management authority of the temporary storage unit 14 of the lower unit 2b, and the management authority of the banknote storage units 18a to 18e of the lower unit 2b.

As described above, when the control unit 11 temporarily stores, in the temporary storage unit 14, the banknotes deposited in the depositing unit 3, and a user performs deposit determination operation or the like, the banknotes temporarily stored in the temporary storage unit 14 are stored in the banknote storage units 18a to 18e. Accordingly, the banknotes in states before and after deposit determination are stored in the temporary storage unit 14.

Generally, banknote management authority before the deposit determination and banknote management authority after the deposit determination are different. Therefore, the temporary storage unit 14 is desirably disposed in a region where the management authority is clarified. In the banknote processing apparatus 1, the temporary storage unit 14 is disposed in a region between the door 7a having the locking unit 7b of the lower unit 2b, and the safe 15 having the locking unit 16b, and therefore it is possible to clarify the management authority of the temporary storage unit 14.

The temporary storage unit 14 is the winding type storage unit in the aforementioned description, but is not limited to this. For example, the temporary storage unit 14 may be a stack type storage unit.

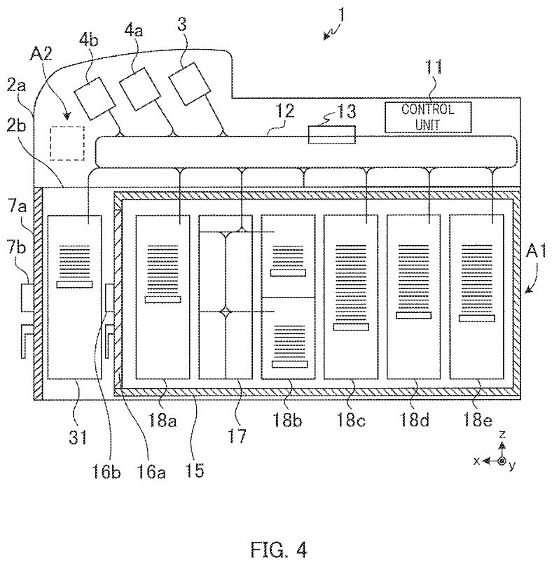

FIG. 4 is another schematic sectional view of the banknote processing apparatus 1 of FIG. 1 as viewed from the +y axis direction. In FIG. 3, the same components as FIG. 2 are denoted by the same reference numerals.

As illustrated in FIG. 4, the banknote processing apparatus 1 has a stack type temporary storage unit 31. The temporary storage unit 31 stacks and stores banknotes in the direction perpendicular to a printing surface.

Thus, the temporary storage unit 14 may be a stack type storage unit. Also, in this case, similarly to the winding type storage unit, for example, banknotes put into the depositing unit 3 can be temporarily stored, or a rejected banknote or the like caused at the time of dispensing can be temporarily stored. The stack type storage unit is used as the temporary storage unit 14, so that the number of banknotes to be stored can be increased compared to the winding type storage unit. The number of banknotes to be stored in the temporary storage unit 14 is equal to or more than the number of banknotes to be stored in the banknote storage unit 18a, so that banknotes in the banknote storage units 18a to 18e can be collected, or banknotes can be replenished in the banknote storage units 18a to 18e. Furthermore, the temporary storage unit 14 may have the same configuration as the banknote storage units 18a to 18e.

The door 16a of the safe 15 is provided on the front surface of the safe 15 in the aforementioned description, but may be provided on a back surface of the safe 15. For example, an door for accessing the inside of the safe 15, and a locking unit for locking the door may be provided on the back surface of the safe 15 illustrated by the arrow A1 of FIG. 4. In this case, a user who has management authority of the temporary storage unit 31 accesses from a front surface of the banknote processing apparatus 1, and a user who has management authority of the banknote storage units 18a to 18e accesses from a back surface of the banknote processing apparatus 1. Thus, the door and the locking unit of the safe 15 are provided on the back surface illustrated by the arrow A1, so that management authority of the temporary storage unit 31, and management authority of the banknote storage units 18a to 18e can be regulated from the direction with respect to the banknote processing apparatus 1.

The temporary storage unit 31 conventionally disposed in the upper unit 2a is disposed in the lower unit 2b. Consequently, a box may be disposed in a space for the temporary storage unit 31 disposed in the upper unit 2a. For example, a box may be disposed in a space illustrated by a dotted line indicated by the arrow A2 of FIG. 4. For example, the box may store a rejected banknote, or store a banknote suspected to be a counterfeit banknote. The box may be a box dedicated to storage with no feeding function. One or more boxes may be provided in the upper unit 2a. In a case in which the box is the box dedicated to storage with no feeding function, the banknote processing apparatus 1 has functionally distinguished units, namely the lower unit 2b having a feeding and storing function, and the upper unit 2a having a processing function such as depositing and dispensing and recognition of a banknote and a storage function.

The banknote processing apparatus 1 has the three locking units 6, 7b, 16b, and therefore a user who uses the banknote processing apparatus 1 can freely determine how to allocate the management authority of the banknote processing apparatus 1.

For example, in a case in which the management authority of the banknote processing apparatus 1 is divided into two, namely management authority of the upper unit 2a and management authority of the lower unit 2b, the personal identification number of the locking unit 6 is informed to a user who has the management authority of the upper unit 2a. The personal identification number of the locking unit 7b and the personal identification number of the locking unit 16b are informed to a user who has the management authority of the lower unit 2b. In a case in which the management authority of the banknote processing apparatus 1 is divided into three, namely management authority of the upper unit 2a, management authority of the temporary storage unit 14, and the management authority of the banknote storage units 18a to 18e, the personal identification number of the locking unit 6 is informed to a user who has the management authority of the upper unit 2a. The personal identification number of the locking unit 7b is informed to a user who has the management authority of the temporary storage unit 14. The two personal identification numbers of the locking units 7b, 16b are informed to a user who has the management authority of the banknote storage units 18a to 18e.

The banknote processing apparatus 1 has the locking unit 6 that limits access to the inside of the upper unit 2a, the locking unit 7b of the door 7a of the lower unit 2b for limiting access to a region where the temporary storage unit 14 is provided, and the locking unit 16b of the safe 15 for limiting access to regions where the banknote storage units 18a to 18e. However, the present invention is not limited to this. For example, the locking unit is provided in the temporary storage unit 14 itself, so that access to the inside of the temporary storage unit 14 can be limited. In this case, even when any one of the locking unit 7b and the locking unit 16b is omitted, similar management authority can be provided. In a case in which management authority (for example, authority to enter a room) of a space where the banknote processing apparatus 1 is installed and management authority of the upper unit 2a are equal, the locking unit 6 may be omitted. In a case in which management authority of the space where the banknote processing apparatus 1 is installed and management authority of the temporary storage unit 14 are equal, the locking unit 7b may be omitted. In a case in which management authority of the upper unit 2a and management authority of the temporary storage unit 14 are equal, the locking unit 6 and the locking unit 7b may be locking units that can be unlocked by the same key. In a case in which management authority of the temporary storage unit 14 and management authority of the banknote storage units 18a to 18e are equal, the locking unit 7b and the locking unit 16b may be locking units that can be unlocked by the same key, or the locking unit 16b may be omitted.

Thus, a locking unit that limits access to the inside may be provided in at least one of the upper unit 2a, the lower unit 2b, the temporary storage unit 14, and the banknote storage units 18a to 18e. Furthermore, locking units may be provided in at least two of the upper unit 2a, the lower unit 2b, the temporary storage unit 14, and the banknote storage units 18a to 18e, and respective keys for unlocking or respective pieces of information to be input to unlock in these locking units may be different.

### Embodiment 2

In Embodiment 2, a method for attaching to a lower unit 2b according to a structure of a winding type temporary storage unit will be described.

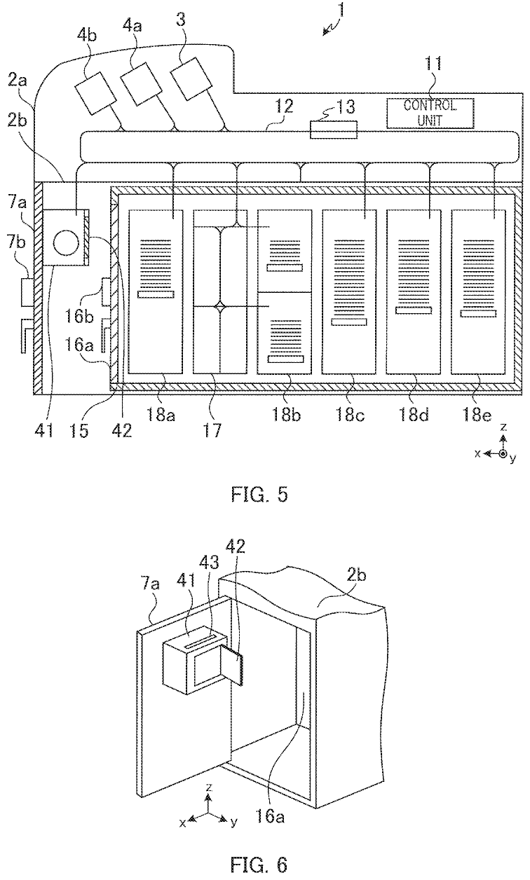

FIG. 5 is a schematic sectional view of a banknote processing apparatus 1 according to Embodiment 2 as viewed from the +y axis direction. In FIG. 5, the same components as FIG. 2 are denoted by the same reference numerals.

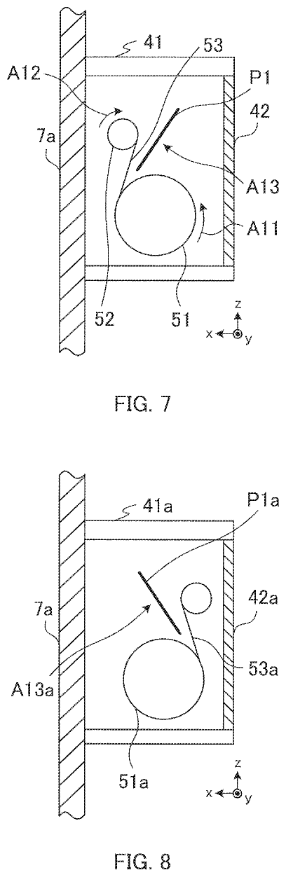

As illustrated in FIG. 5, the lower unit 2b of the banknote processing apparatus 1 has a winding type temporary storage unit 41. The temporary storage unit 41 is provided on an inner side of an door 7a of the lower unit 2b. Although description will be made below (for example, refer to FIG. 7), the temporary storage unit 41 is provided on the inner side of the door 7a in such a manner as to enable access to the inner face of a banknote to be wound, when the door 7a is opened.

The temporary storage unit 41 has an isolation member that isolates the inside of the temporary storage unit from the outside. The isolation member is, for example, a door 42. The door 42 is a door for accessing the inside of the temporary storage unit 41. The door 42 is provided on a surface (surface on a safe 15 side) on a side opposite to a surface fixed to the door 7a of the temporary storage unit 41.

FIG. 6 is a schematic perspective view of the temporary storage unit 41 when the door 7a of the lower unit 2b is opened. In FIG. 6, the same components as FIG. 5 are denoted by the same reference numerals. In FIG. 6, the door 7a of the lower unit 2b, and an door 16a of the safe 15 are illustrated in addition to the temporary storage unit 41.

As illustrated in FIG. 6, the temporary storage unit 41 is fixed to the inner side of the door 7a. Accordingly, when the door 7a is opened, the temporary storage unit 41 appears from the inner side of the lower unit 2b.

FIG. 6 illustrates the temporary storage unit 41 in a state in which the door 42 is open. As illustrated in FIG. 6, a user can access the inside of the temporary storage unit 41 by opening the door 42. That is, the user can perform maintenance of the temporary storage unit 41 by opening the door 7a of the lower unit 2b and opening the door 42 of the temporary storage unit 41.

The temporary storage unit 41 has an opening 43 in an upper surface. The temporary storage unit 41 stores, from the opening 43, a banknote transported from a transport unit 12, and temporarily stores the banknote in a state in which the door 7a is closed (for example, in a state of the door 7a illustrated in FIG. 5). Additionally, the temporary storage unit 41 feeds out the banknote temporarily stored, from the opening 43 to the transport unit 12.

FIG. 7 is a schematic sectional view of the temporary storage unit 41 as viewed from the +y axis direction. In FIG. 7, the same components as FIG. 5 are denoted by the same reference numerals. As illustrated in FIG. 7, the temporary storage unit 41 has drums 51, 52, and a tape 53. FIG. 7 also illustrates a banknote P1 temporarily stored in the temporary storage unit 41.

In a case in which the banknote P1 is temporarily stored, the drum 51 rotates in the arrow A11 direction of FIG. 7. In a case in which the banknote P1 is temporarily stored, the drum 52 around which the tape 53 is wound rotates in the arrow A12 direction of FIG. 7. The tape 53 wound around the drum 52 fed out to the drum 51 by rotation illustrated by the arrow A12 of FIG. 7, and the tape 53 fed out to the drum 51 is wound around the drum 51 by rotation illustrated by the arrow A11 of FIG. 7.

In a case in which the banknote P1 is temporarily stored in the temporary storage unit 41, the banknote P1 is transported between the tape 53 and outer periphery of the drum 51 by a transport unit (not illustrated) inside the temporary storage unit 41. The banknote P1 is sandwiched between the tape 53 and the outer periphery of the drum 51 to be wound around the drum 51.

The arrow A13 of FIG. 7 illustrates a surface of the banknote P1, the surface being in contact with the outer periphery of the drum 51. That is, the arrow A13 illustrates the inner face of the banknote P1 which is wound around the drum 51.

As described above, the temporary storage unit 41 is provided on the inner side of the door 7a in such a manner as to enable access to the inner face of the banknote P1 to be wound (surface illustrated by the arrow A13) when the door 7a is opened. Therefore, when the door 7a of the lower unit 2b is opened and the door 42 of the temporary storage unit 41 is opened, the tape 53 does not exist on a surface of the banknote P1 before winding or in the middle of the winding, the surface being illustrated by the arrow A13. Consequently, for example, even when a jam of banknotes occurs inside the temporary storage unit 41, the user can easily perform maintenance. Feeding operation of a banknote of the temporary storage unit 41 is operation reverse to the aforementioned storing operation.

On the other hand, as described below, in a case in which the temporary storage unit 41 is provided on the inner side of the door 7a in such a manner as to prevent access to the inner face of the banknote P1 to be wound, maintenance becomes difficult.

FIG. 8 is a schematic sectional view of a temporary storage unit 41a for comparison with the temporary storage unit 41 of FIG. 7. The temporary storage unit 41a illustrated in FIG. 8 is different from the temporary storage unit 41 illustrated in FIG. 7 in that the inner face of a banknote P1a to be wound around a drum 51a (surface illustrated by the arrow A13a) is directed to an door 7a side. Therefore, when the door 7a of a lower unit 2b is opened and an door 42a of the temporary storage unit 41a is opened, the banknote P1a exists on the other side of a tape 53a.

Accordingly, in arrangement like the example of FIG. 8, for example, when a jam of banknotes occurs inside the temporary storage unit 41a, a user cannot easily access the banknote P1a, and maintenance becomes difficult.

As described above, when the door 7a is opened, the winding type temporary storage unit 41 is disposed on the inner side of the door 7a in such a manner as to enable access to the inner face of the banknote to be wound. Consequently, the user can easily perform maintenance of the, temporary storage unit 41.

### Embodiment 3

In Embodiment 3, a method for attaching to a lower unit 2b of a stack type temporary storage unit will be described.

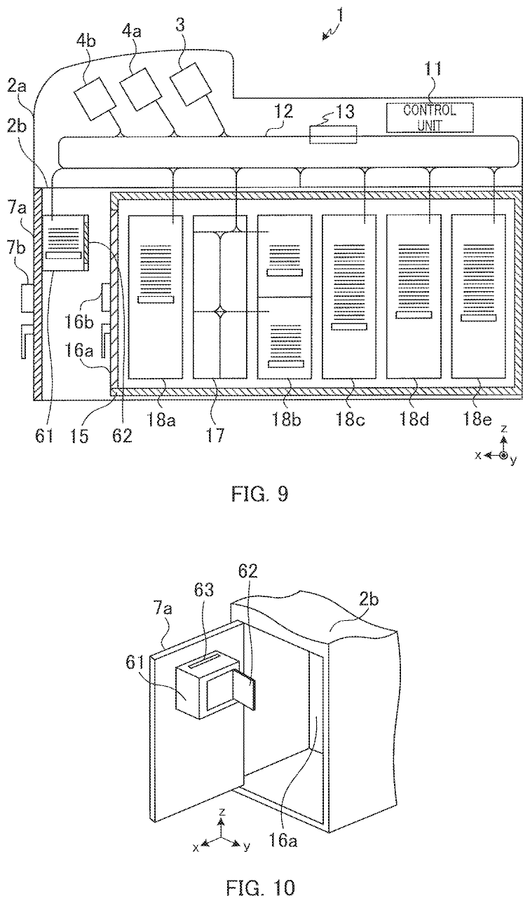

FIG. 9 is a schematic sectional view of a banknote processing apparatus 1 according to Embodiment 3 as viewed from the +y axis direction. In FIG. 9, the same components as FIG. 2 are denoted by the same reference numerals.

As illustrated in FIG. 9, the lower unit 2b of the banknote processing apparatus 1 has a stack type temporary storage unit 61. The temporary storage unit 61 is provided on an inner side of an door 7a of the lower unit 2b. The temporary storage unit 61 has a door 62 to be opened or closed for accessing a banknote housed therein.

When a user opens the door 7a, the temporary storage unit 61 is fixed to the inner side of the door 7a of the lower unit 2b in such a manner as to enable access to the door 62.

FIG. 10 is a schematic perspective view of the temporary storage unit 61 when the door 7a of the lower unit 2b is opened. In FIG. 10, the same components as FIG. 9 are denoted by the same reference numerals. In FIG. 10, the door 7a of the lower unit 2b and an door 16a of a safe 15 are illustrated in addition to the temporary storage unit 61.

As illustrated in FIG. 10, the temporary storage unit 61 is fixed to the inner side of the door 7a. Accordingly, when the door 7a is opened, the temporary storage unit 61 appears from the inner side of the lower unit 2b.

FIG. 10 illustrates the temporary storage unit 61 in a state in which the door 62 is open. As illustrated in FIG. 10, a user can access the inside of the temporary storage unit 61 by opening the door 62. That is, the user can perform maintenance of the temporary storage unit 61 by opening the door 7a of the lower unit 2b and opening the door 62 of the temporary storage unit 61.

The temporary storage unit 61 has an opening 63 in an upper surface. The temporary storage unit 61 stores, from the opening 63, a banknote transported from a transport unit 12, and temporarily stores the banknote in a state in which the door 7a is closed (for example, in a state of the door 7a illustrated in FIG. 9). Additionally, the temporary storage unit 61 feeds out, from the opening 63 to the transport unit 12, the temporarily stored banknote.

As described above, the temporary storage unit 61 has the door 62 for taking out the stored banknote, and is disposed on the door 7a in such a manner as to enable access to the door 62 when the door 7a of the lower unit 2b is opened. Consequently, the user can easily perform maintenance of the temporary storage unit 61 by opening the door 7a of the lower unit 2b and the opening the door 62 of the temporary storage unit 61.

### Embodiment 4

In Embodiment 3, the door 62 of the stack type temporary storage unit 61 is provided on a surface on the safe 15 side of the temporary storage unit 61, as illustrated in FIG. 9. In Embodiment 4, an door of a stack type temporary storage unit is provided on a surface on an door 7a side of a lower unit 2b of the temporary storage unit.

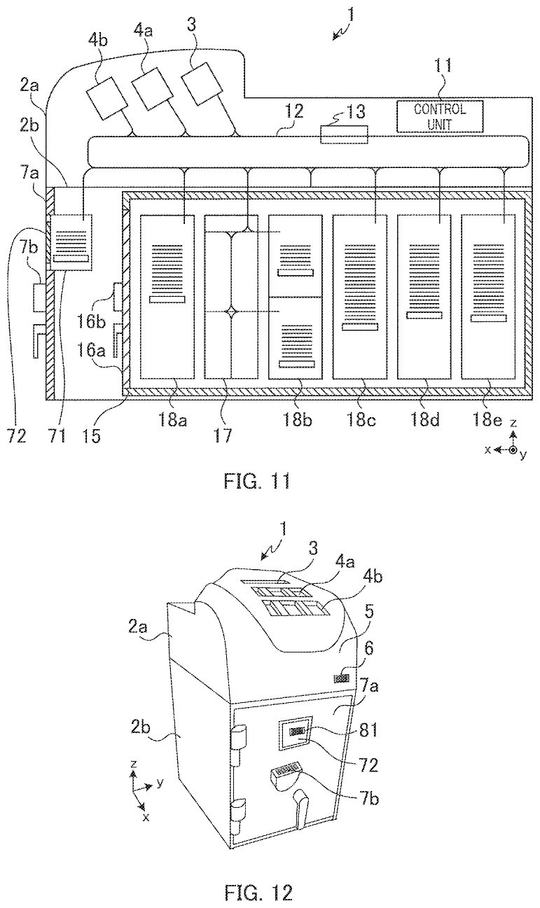

FIG. 11 is a schematic sectional view of a banknote processing apparatus 1 according to Embodiment 4 as viewed from the +y axis direction. In FIG. 11, the same components as FIG. 9 are denoted by the same reference numerals.

As illustrated in FIG. 11, the lower unit 2b of the banknote processing apparatus 1 has a stack type temporary storage unit 71. The temporary storage unit 71 is provided on the inner side of the door 7a of the lower unit 2b. The temporary storage unit 71 has a door 72 for accessing a banknote housed therein.

The temporary storage unit 71 is fixed to the inner side of the door 7a of the lower unit 2b in such a manner as to enable a user to access the door 72 from a front surface of the door 7a.

FIG. 12 is a perspective view of the banknote processing apparatus 1 of FIG. 11. In FIG. 12, the same components as FIG. 11 are denoted by the same reference numerals.

As illustrated in FIG. 12, the door 72 of the temporary storage unit 71 can be accessed from a front surface of the lower unit 2b. A locking unit 81 is provided on a front surface of the door 72.

The locking unit 81 is, for example, an electronic lock, and limits access to the inside of the temporary storage unit 71. For example, the door 72 of the temporary storage unit 71 cannot be opened when a preset personal identification number is not input to the locking unit 81.

As described above, the temporary storage unit 71 is disposed on the inner surface of the door 7a in such a manner as to enable access to the door 72 from the front surface of the door 7a. Consequently, even when the user does not open the door 7a of the lower unit 2b, the user can open the door 72 of the temporary storage unit 71, and can easily perform maintenance of the temporary storage unit 71.

### Embodiment 5

In Embodiment 5, a temporary storage unit is housed in a safe.

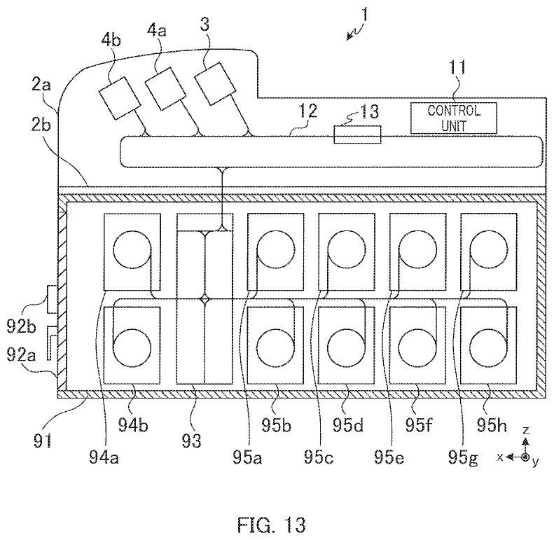

FIG. 13 is a schematic sectional view of a banknote processing apparatus 1 according to Embodiment 5 as viewed from the +y axis direction. In FIG. 13, the same components as FIG. 2 are denoted by the same reference numerals.

As illustrated in FIG. 13, a lower unit 2b of the banknote processing apparatus 1 has a safe 91, a door 92a, a locking unit 92b, a transport module 93, temporary storage units 94a, 94b, and banknote storage units 95a to 95h.

The door 92a for accessing the inside of the safe 91 is provided on a front surface of the safe 91. The locking unit 92b is provided on a front surface of the door 92a.

The locking unit 92b is, for example, an electronic lock, and limits access to the inside of the safe 91. For example, the locking unit 92b cannot be opened when a preset personal identification number is not input to the locking unit 92b.

The transport module 93 is housed in the safe 91. The transport module 93 has a plurality of diverters that switch banknote transport routes, similarly to the transport module 17 described with reference to FIG. 2. The transport module 93 switches transport destinations of a banknote in accordance of control of the diverters by the control unit 11.

For example, the transport module 93 transports banknotes transported from a transport unit 12 of FIG. 13 to the temporary storage units 94a, 94b, or transports banknotes transported from the transport unit 12 of FIG. 13 to the banknote storage units 95a to 95h. Additionally, the transport module 93 transports the banknotes fed out from the temporary storage units 94a, 94b to the transport unit 12, or transports the banknotes fed out from the banknote storage units 95a to 95h to the transport unit 12.

The temporary storage units 94a, 94b are winding type temporary storage units. The temporary storage units 94a, 94b are housed in the safe 91. The temporary storage units 94a, 94b are detachable from the safe 91.

The banknote storage units 95a to 95h are winding type banknote storage units. The banknote storage units 95a to 95h are housed in the safe 91. The banknote storage units 95a to 95h are detachable from the safe 91.

As described above, the temporary storage units 94a, 94b are housed in the safe 91 housing the banknote storage units 95a to 95h therein. Consequently, maintenance of the temporary storage units 94a, 94b is facilitated.

Management authority of the safe 91 can be separated from management authority of the lower unit 2b by the locking unit 92b.

The banknotes transported by the transport unit 12 are transported to the temporary storage units 94a, 94b and the banknote storage units 95a to 95h through the transport module 93. Consequently, the safe 91 only needs to have an opening of the transport unit connecting the transport unit 12 and the transport module 93, and the banknote processing apparatus 1 can enhance security. For example, in a case of the example of FIG. 13, the safe 91 has a single opening for the transport unit connecting the transport unit 12 and the transport module 93. Consequently, the banknote processing apparatus 1 can enhance security.

A plurality of the temporary storage units 94a, 94b are provided so that the following processing can be performed. For example, in depositing, deposited banknotes can be classified into a plurality of the temporary storage units 94a, 94b and be temporarily stored on the basis of a recognition result. For example, deposited banknotes may be classified for each denomination, or may be classified for fitness. Only banknotes suspected to be counterfeit banknotes may be separately classified. Only banknotes to be regarded as rejected banknotes may be classified, and discharged to the dispensing unit 4a in a lamp. In depositing, in a case in which banknotes, the number of which exceeds the number of banknotes which can be stored in a single temporary storage unit, are deposited, the banknotes may be divided and temporarily stored in a plurality of the temporary storage units 94a, 94b. A plurality of the temporary storage units 94a, 94b may be alternately used on the basis of time or the number of stored banknotes.

The disclosure of the specification, the drawings, and the abstract included in Japanese Patent Application No. 2017-049787 filed on Mar. 15, 2017 is incorporated herein by reference as if set forth in its entirety.

### REFERENCE SIGNS LIST

1 Banknote processing apparatus
2a Upper unit
2b Lower unit
6 Locking unit
7a door
7b Locking unit
11 Control unit
12 Transport unit
13 Recognition unit
14 Temporary storage unit
15 Safe
16a door
16b Locking unit
17 Transport module
18a to 18e Banknote storage unit

1. A banknote processing apparatus, comprising:
an upper unit including a depositing unit and a banknote recognition unit, the depositing unit being configured to deposit a banknote in the banknote processing apparatus, the banknote recognition unit being configured to recognize the banknote deposited from the depositing unit; and
a lower unit including a temporary storage unit and a banknote storage unit, the temporary storage unit being configured to temporarily store the banknote recognized by the banknote recognition unit, the banknote storage unit being configured to store the banknote stored in the temporary storage unit.

2. The banknote processing apparatus according to claim 1, wherein management authority of the upper unit is different from management authority of the lower unit.

3. The banknote processing apparatus according to claim 1, wherein:
a region in which the temporary storage unit is housed is isolated from a region in which the banknote storage unit is housed, and
management authority of the temporary storage unit is different from management authority of the banknote storage unit.

4. The banknote processing apparatus according to claim 1, wherein at least one of the upper unit, the lower unit, the temporary storage unit, and the banknote storage unit has a locking unit to limit access to inside thereof.

5. The banknote processing apparatus according to claim 1, wherein:
each of at least two of the upper unit, the lower unit, the temporary storage unit, and the banknote storage unit has a locking unit to limit access to inside thereof,
each locking unit is capable of unlocking with a key or a piece of unlocking information that is input to the locking unit, and each key to each locking unit or each piece of unlocking information input to each locking unit is different from each other.

6. The banknote processing apparatus according to claim 5, wherein
the locking unit includes:
a first locking unit configured to limit access to inside of the upper unit;
a second locking unit configured to limit access to a region where the temporary storage unit is provided; and
a third locking unit configured to limit access to a region where the banknote storage unit is provided, and
each key to the first locking unit, the second locking unit, and the third locking unit or each piece of unlocking information input to the first locking unit, the second locking unit, and the third locking unit is different from each other.

7. The banknote processing apparatus according to claim 4, wherein:
the banknote storage unit is housed in a safe having a safe door, and
the locking unit is arranged at the sate door that isolates inside of the safe from outside of the safe.

8. The banknote processing apparatus according to claim 7, comprising
an outer door configured to isolate inside of the lower unit from outside of the lower unit, wherein
the temporary storage unit is provided outside the safe, and the locking unit is provided on the outer door.

9. The banknote processing apparatus according to claim 8, wherein the safe and the outer door are open toward respective different directions of the device.

10. The banknote processing apparatus according to claim 1, comprising an outer door that isolates inside of the lower unit from outside of the lower unit, wherein
the temporary storage unit is a winding type storage unit that is disposed on an inner side of the outer door in such a manner as to enable access to n inner face of a banknote to be wound, when the outer door is opened.

11. The banknote processing apparatus according to claim 1, comprising an outer door that isolates inside of the lower unit from outside, wherein
the temporary storage unit is a stack type storage unit that has an isolation member that isolates inside of the temporary storage unit from outside of the temporary storage unit, and is disposed on an inner side of the outer door in such a manner as to enable access to the isolation member when the outer door is opened.

12. The banknote processing apparatus according to claim 1, comprising an outer door that isolates inside of the lower unit from outside of the lower unit,
wherein the temporary storage unit is a stack type storage unit that includes an isolation member that isolates inside of the temporary storage unit from outside of the temporary storage unit, and is disposed on an inner side of the outer door in such a manner as to enable access to the isolation member from a front surface of the outer door.

13. The banknote processing apparatus according to claim 1, wherein:
the banknote storage unit is housed in a safe, and
the temporary storage unit is housed in the safe that houses the banknote storage unit therein.
